(19) United States
(12) Patent Application Publication
(10) Pub. No.: US 2011/0125724 A1
(43) Pub. Date: May 26, 2011

(54) INTELLIGENT SEARCH SYSTEM

(76) Inventor: Kim MO, Sydney (AU)

(21) Appl. No.: 12/699,038

(22) Filed: Feb. 2, 2010

(30) Foreign Application Priority Data
Nov. 20, 2009 (IB) PCT/IB2009/007933

(51) Int. Cl. G06F 17/30

(52) U.S. Cl. 707/706; 707/722; 707/E17.014; 707/E17.016; 707/E17.015

(57) ABSTRACT

A method and system for intelligent searching having a return result count module for determining the search result count for a keyword as well as a sequence of keywords and returning the result count in real time and an auto-determine module for automatically deciding whether keywords entered by a user should be combined using union (conjunction) or intersection (disjunction).

### CROSS REFERENCES TO RELATED APPLICATIONS

This application is an application which claims benefit of co-pending International Patent Application Serial No. PCT/IB2009/007933 filed Nov. 20, 2009. This application is hereby incorporated by reference in its entireties.

### BACKGROUND

The advent of the internet has meant that a wealth of information is available to any user at the click of a mouse. In recent years, there has furthermore been an exponential increase in the amount of information available on the internet as a result of users generating contents in social networking sites. The contents come in a diverse range of forms and formats, e.g., short text (Twitter), blogs (TripAdvisor), photos (Flickr), videos (YouTube) or a combination of these formats (Facebook), etc. Most search engines currently available on the internet are very effective in helping users find text-based objects, e.g., web pages, documents, etc, but they are not effective when searching for non-text objects, such as photos, videos, music, products in an online store or people. A method of tagging these non-text objects has been adopted by websites to deal with this problem. For example, a video may be tagged “Sydney”, “Vacation”, “Beach”, “Surfing” by a YouTube user and users will be able to find the video or other similarly tagged videos by entering one or more of these keywords or tags.

However, these websites still perform the search by matching keywords in text as they are entered, which means that the video in the example above will not be found if the video-owner misspelt a word while tagging or a user chooses a different word (eg “Holiday” instead of “Vacation”) while searching. Similarly, a user entering “New South Wales” may not find the video even though Sydney is in the state of New South Wales. Moreover, a user not using the English language may not find the video at all.

Another problem that is frequently experienced by users is that the search returns irrelevant results and/or too may results, thus requiring users to inspect the results to filter out the irrelevant ones. Some websites adopt a hierarchy approach to guide users through a more structured search process to eliminate irrelevant results by presenting a list of choices in a menu. For example, instead of searching for “Sony DVD players” on an online shop, users go through steps choosing perhaps brand first from a menu of available brands, then product type, then features, price range, etc. Users may be able to expand or restrict the result set by specifying additional items or removing items on the search menu.

There are several issues with this approach. This approach is not scalable (i.e. the complexity of implementation and maintenance of the user-interface and database becomes increasingly disproportionate to the size of the database)—as the number of products or product features grows, not only will it become increasingly difficult to maintain the user interface, users will also find such a search system too complex to navigate. Users may want to specify their preferences in a different order (e.g., price range or features first before brand) and a user interface that caters for different combinations of user preferences will also be difficult to implement and maintain.

Another frustration most users experience when searching is the lack of interaction or feedback from the website during the keyword building phase to inform users whether the search will end up with too many or too few results. Users may not know what keywords or combinations of keywords will return the most appropriate results and in what order they should be specified.

### SUMMARY

The intelligent search engine described herein may be used to search objects within a database, either centrally located or distributed. The intelligent search engine may further be extended to include searching for objects on a distributed network, such as the World Wide Web (WWW), by creating a database for indexing and tagging these objects. The intelligent search engine does not require users to specify the keywords in any order and informs users the size of the result set during the keyword building phase and the auto-suggestion feature presents users with only keywords that will return results based on the keywords that users have already entered.

In one embodiment, a search engine comprises a return result count module for determining the search result count for a sequence of keywords as well as each word in the sequence of keywords and returning the result count in real time, an auto-suggest module for automatically suggesting a list of keywords that may be applicable to a users search and an auto-determine module for automatically deciding whether an additional keyword entered by the user is a union or an intersection of the previous search.

In another embodiment, a computer implemented method for searching comprises receiving a search request from a user and returning in real time a result count for a keyword sequence in the search request as well as each keyword in the keyword sequence. The method further comprises automatically suggesting a list of applicable keywords for the keyword sequence as well as each keyword in the keyword sequence, and automatically determining how keywords specified by users should be combined using union (conjunction) or intersection (disjunction).

These and other objects, along with advantages and features herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 shows a flow chart of a method for processing a search query in accordance with an embodiment of the invention;

FIGS. 2a-e, g-j and m-v show different views of a user interface in accordance with an embodiment of the invention;

FIGS. 2f and k-l show flowcharts of different functions of a system in accordance with an embodiment of the invention; and

FIG. 3 shows a block diagram of a system for processing a search query in accordance with an embodiment of the invention.

### DETAILED DESCRIPTION

In the following detailed description, reference is made to the accompanying drawings, which form a part hereof. In the drawings, similar symbols typically identify similar components, unless the context dictates otherwise. The illustrative embodiments described in the detailed description, drawings, and claims are not meant to be limiting. Other embodiments may be utilized, and other changes may be made, without departing from the spirit or scope of the subject matter presented here.

It will be readily understood that the aspects of the present disclosure, as generally described herein, and illustrated in the Figures, can be arranged, substituted, combined, and designed in a wide variety of different configurations, all of which are explicitly contemplated and make part of this disclosure. This disclosure is drawn, inter alia, to methods, apparatus, computer programs and systems related to processing of searches performed using a computer. The system may be used on its own as a standalone system or it may be used in multiplicity as part of a larger system.

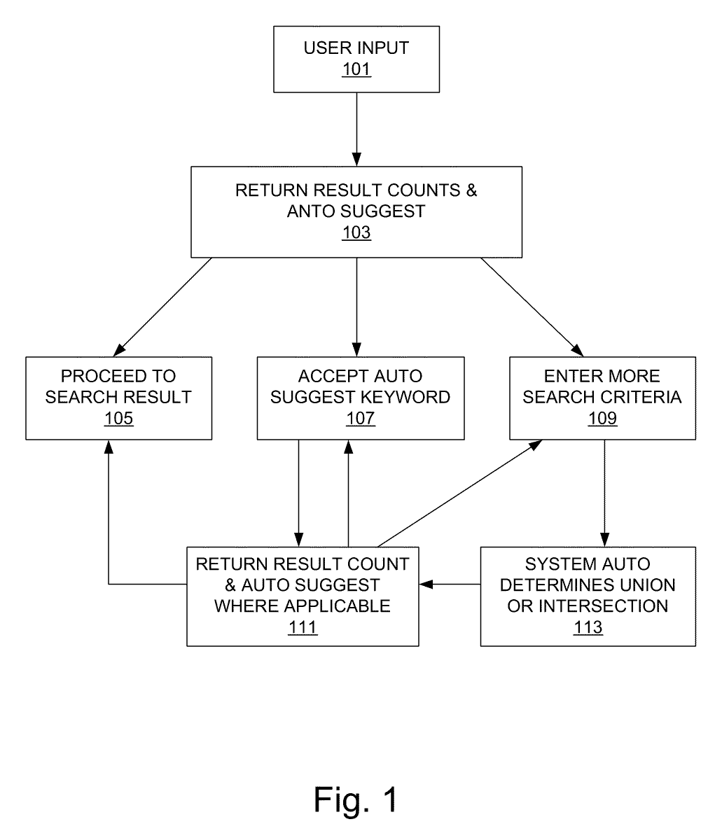

FIG. 1 shows a flow chart of a method for processing a search query in accordance with an embodiment of the invention. As shown, a user inputs a search query in step 101. The system returns a real-time search result count to the user as well as automatically suggests one or more list of search keywords in step 103. In some embodiments, multi-language support may be provided. Based on the response from the system, the user may proceed to the search result as shown in step 105, select one of the search keywords in the lists as suggested by the system in step 107 or further refine the search by typing in additional criteria in step 109. If the user chooses to select a search keyword in the lists as suggested by the system, step 111 returns a real-time search result count to the user and where applicable, further suggests one or more list of search keywords. In other embodiments, step 111 may further provide multi-language support for the keywords.

Alternatively, if the user chooses to further refine the search, the system, in step 113 automatically determines whether the additional criteria should be a union (conjunction) or intersection (disjunction) of the previous search criteria. If more than one additional criteria is added, the system will automatically determine how all the search criteria entered or selected by the user should be combined. The real-time search result count is returned via step 111 to the user and where applicable, further one or more list of search keywords may be suggested and multi-language support for the keywords may be provided. The user may at this stage proceed to the search result or select from the lists suggested a search keyword or the equivalent of the keyword in Chinese, for example, or further refine the search and steps 107-113 will repeat until the user proceeds to the search result in step 105.

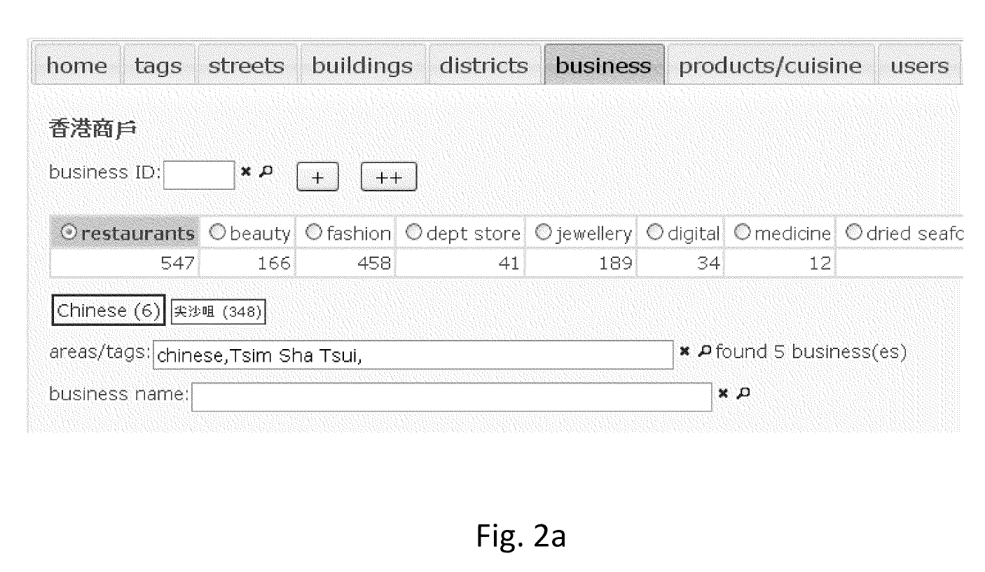

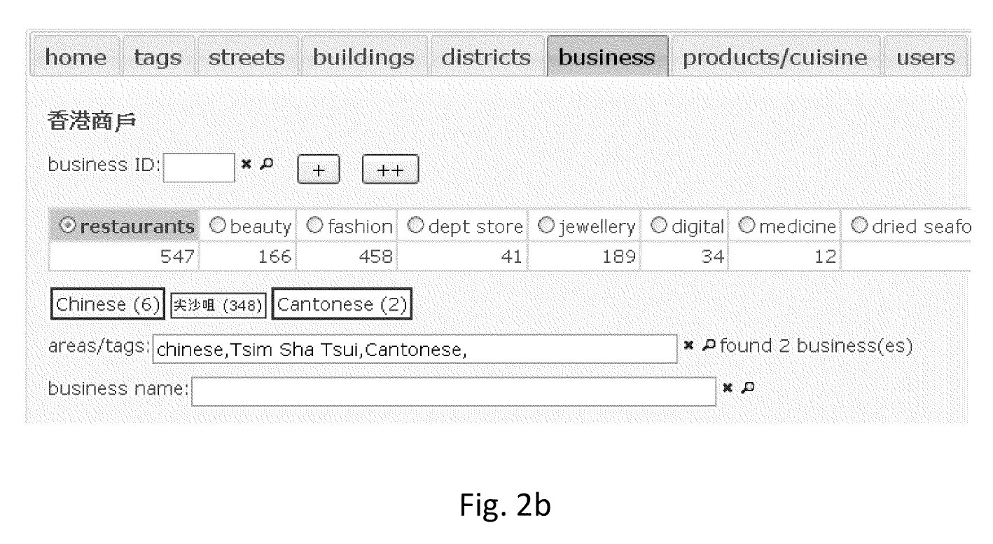

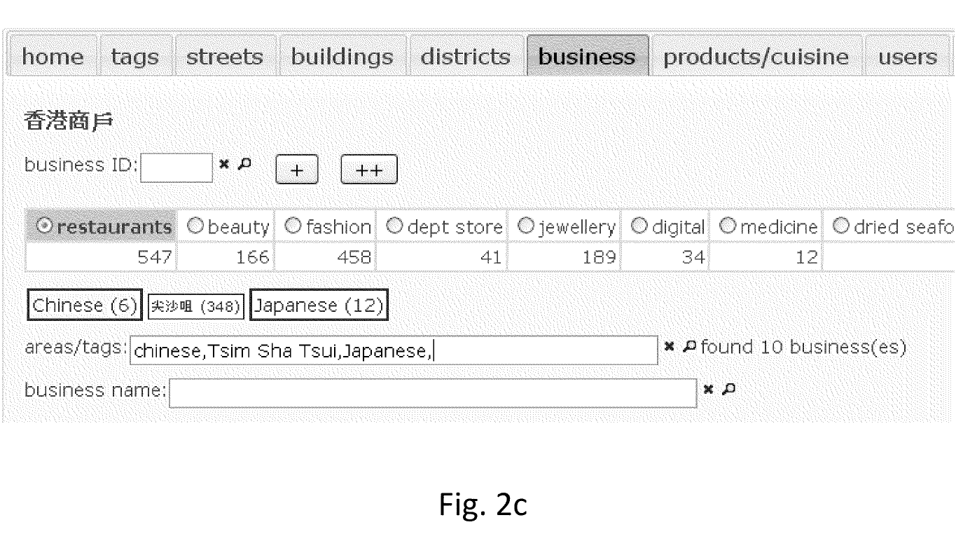

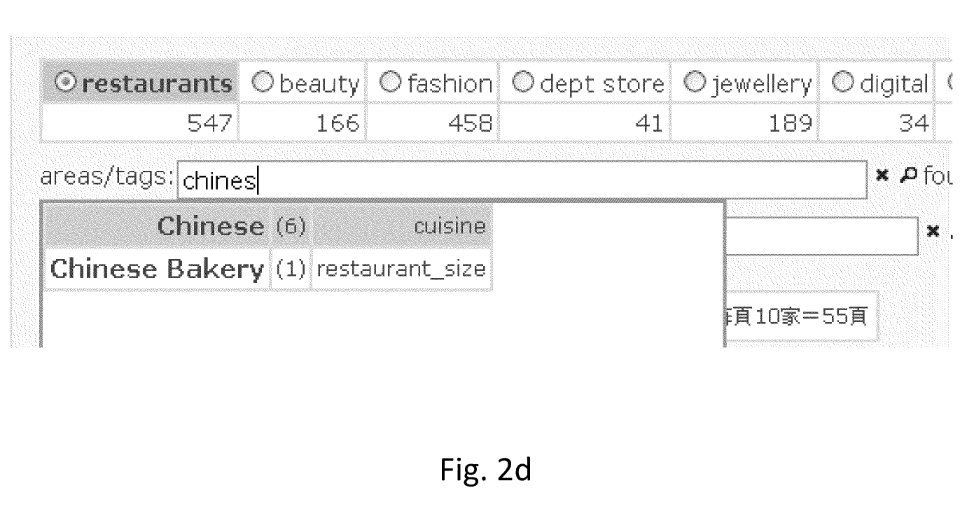

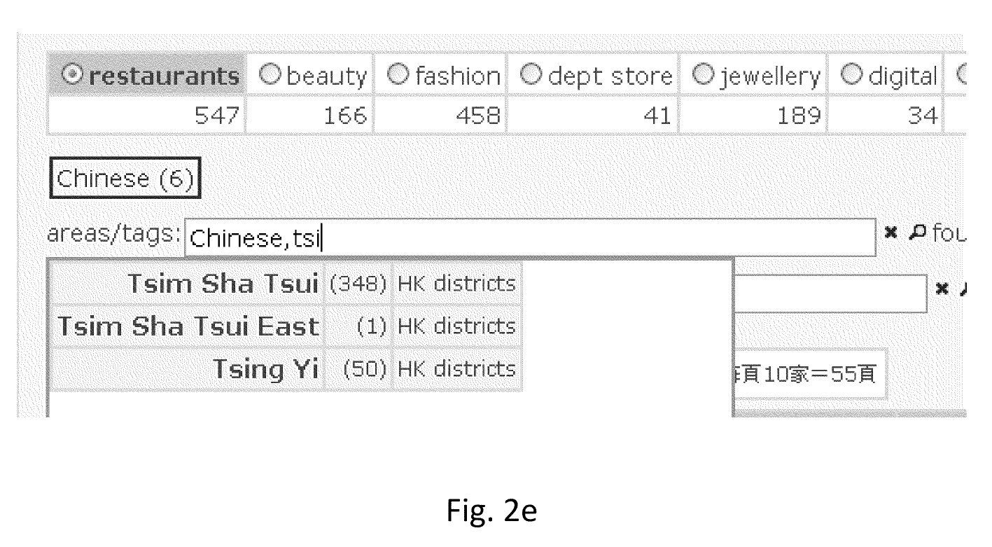

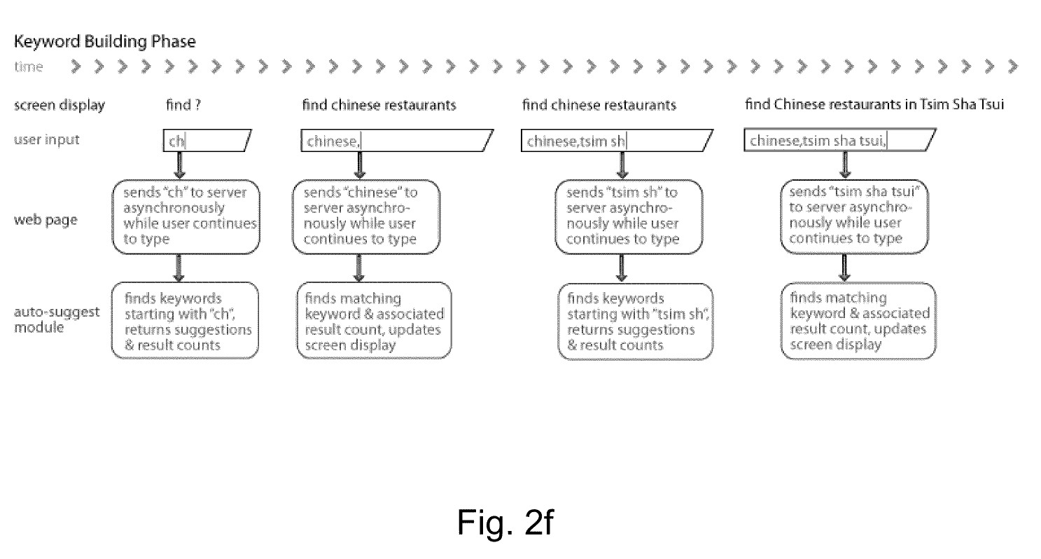

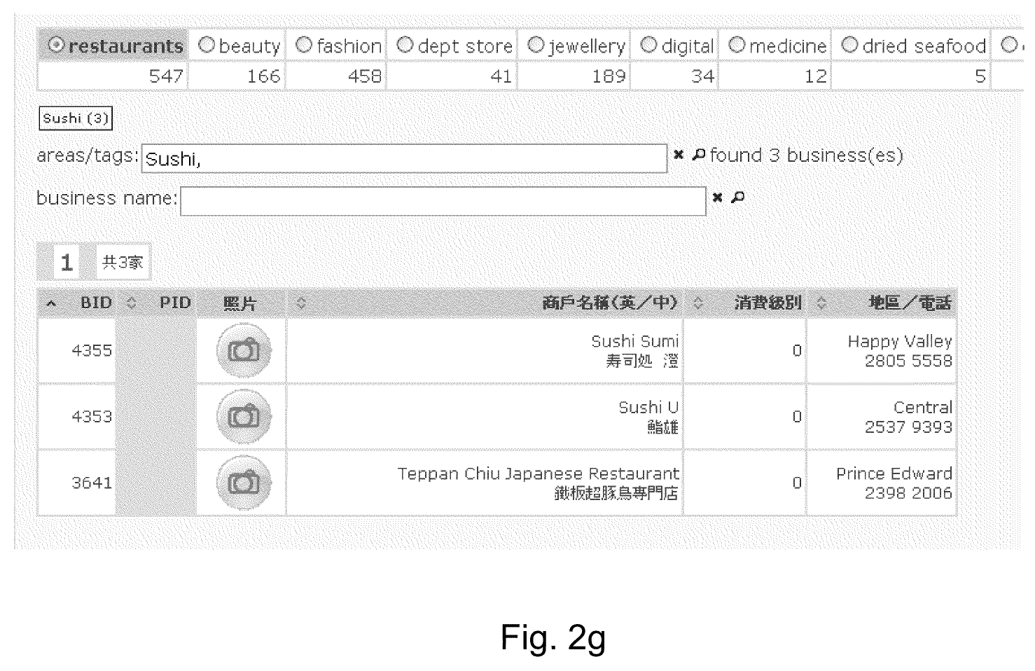

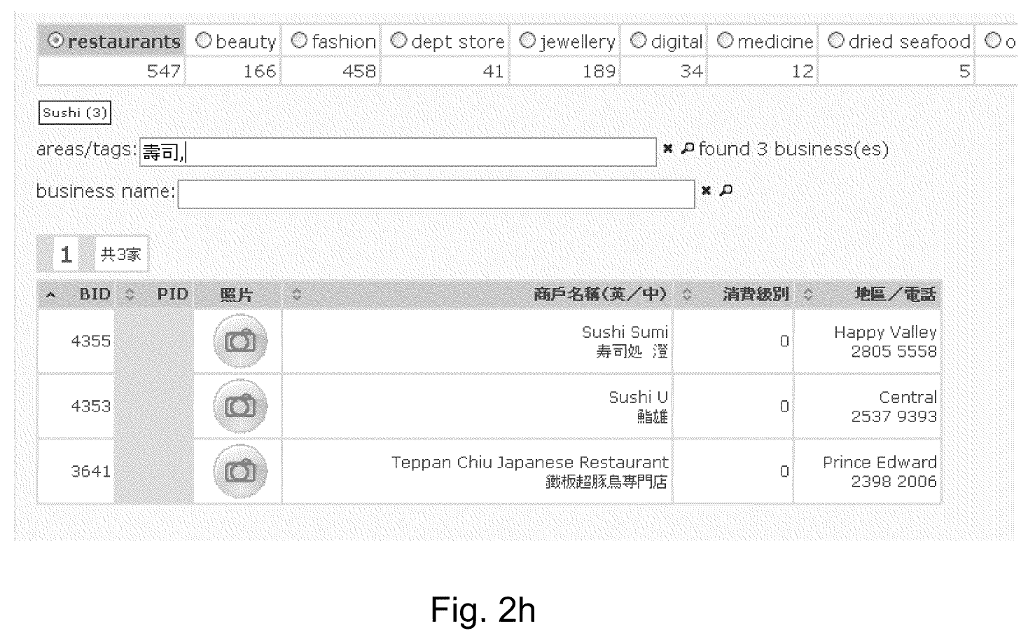

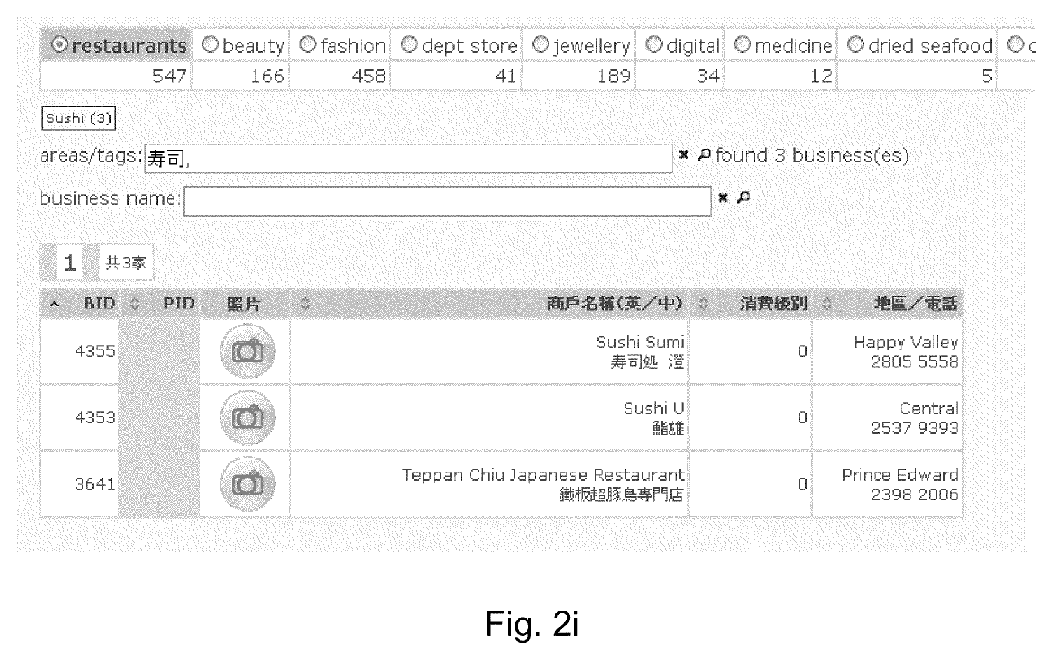

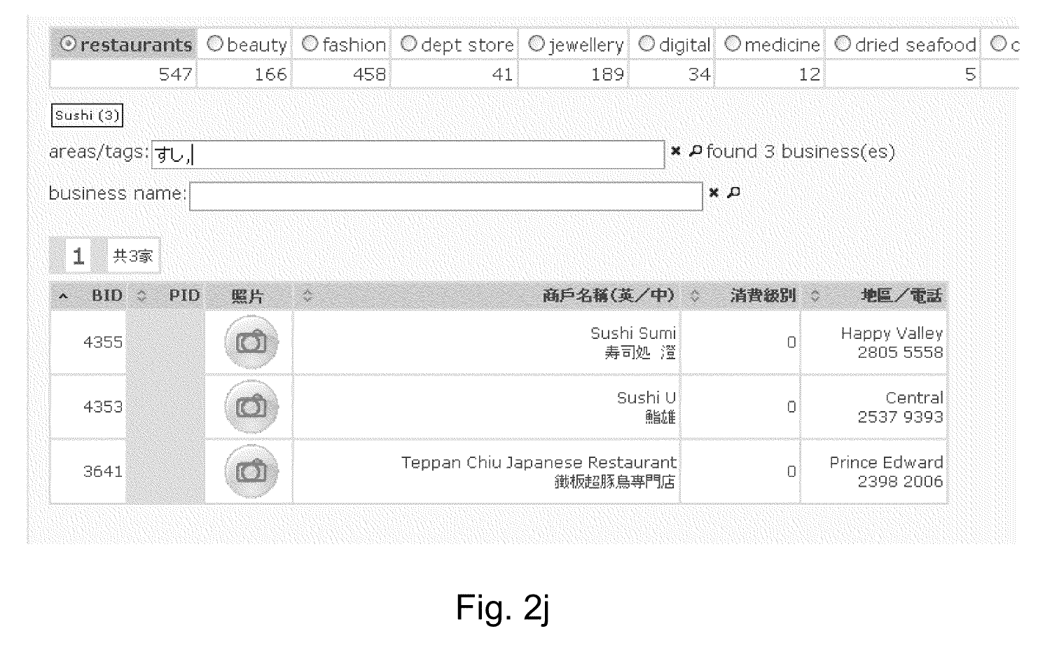

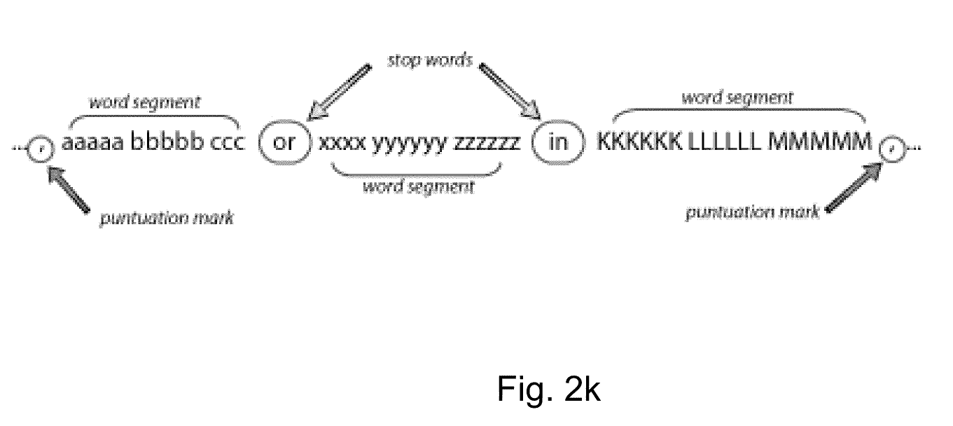

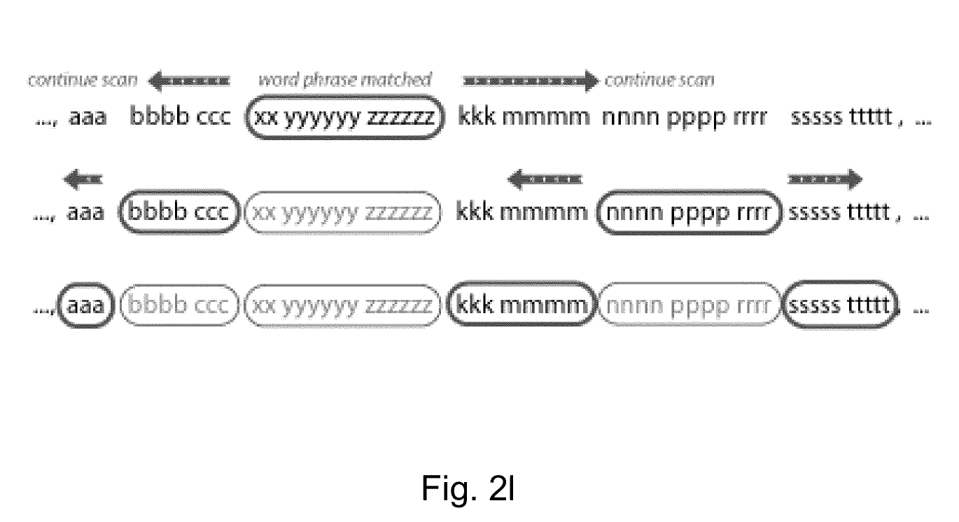

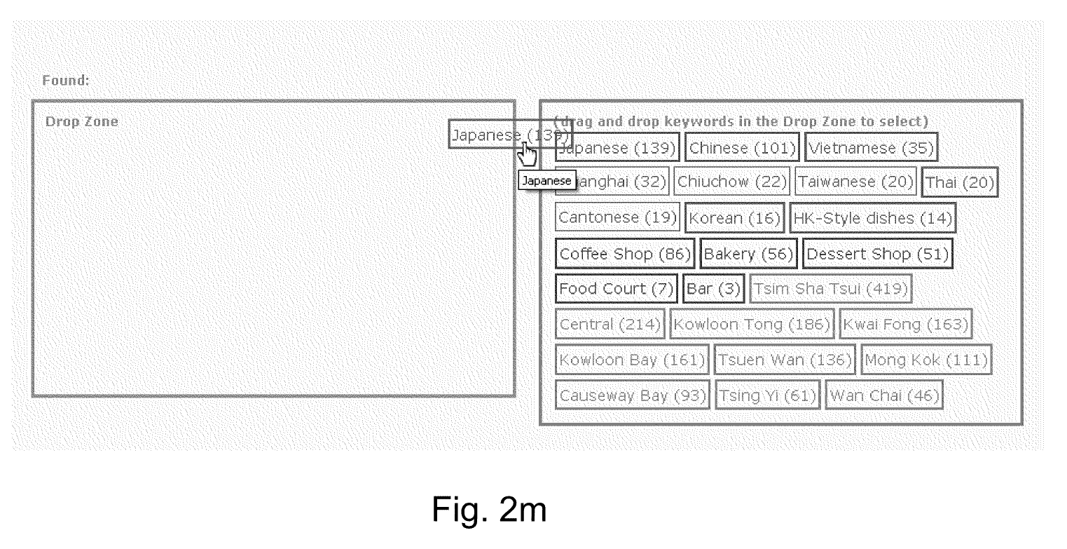

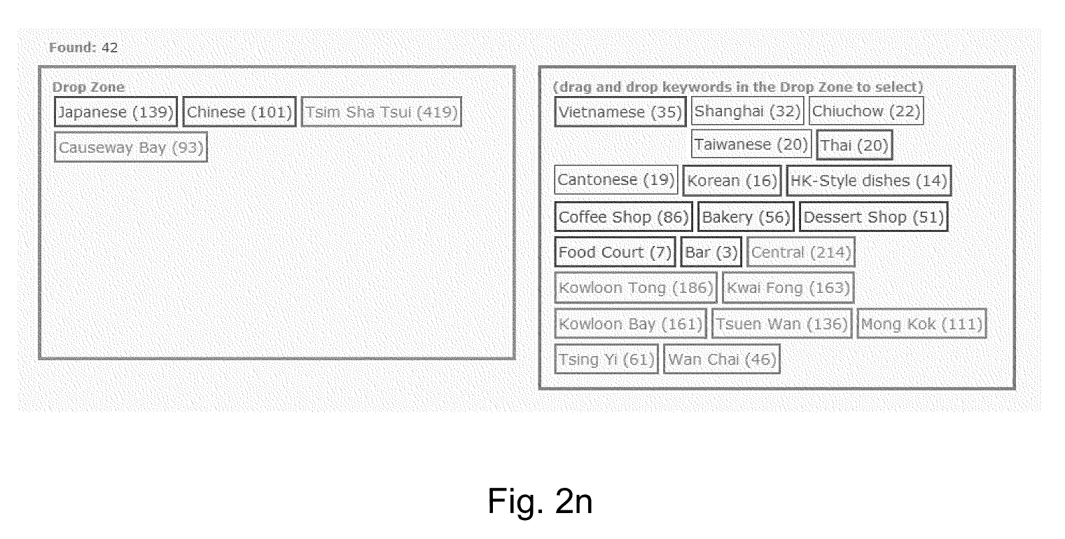

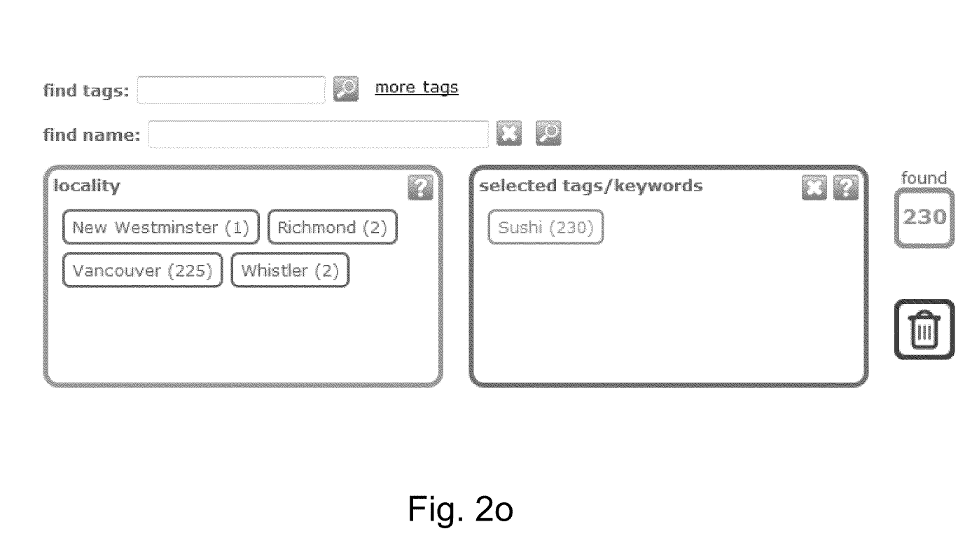

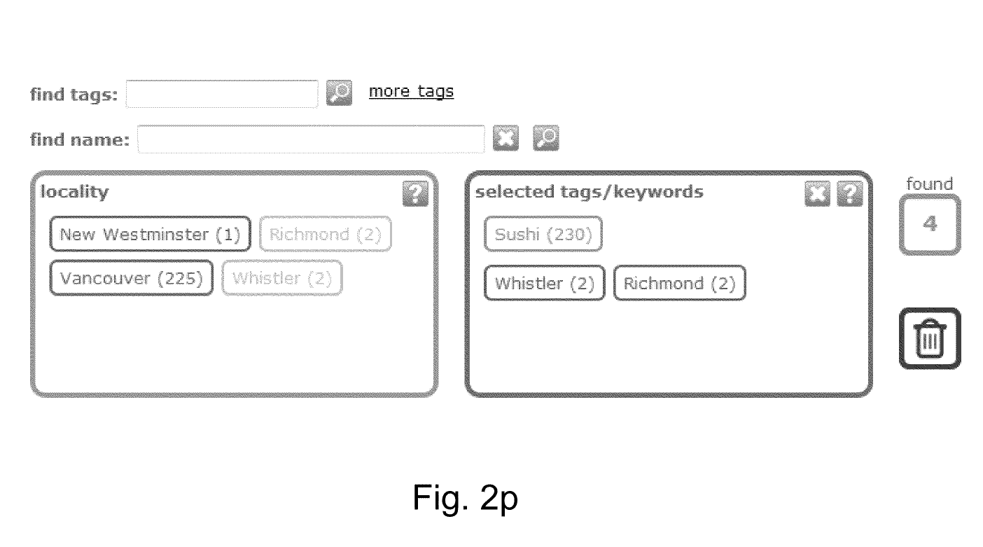

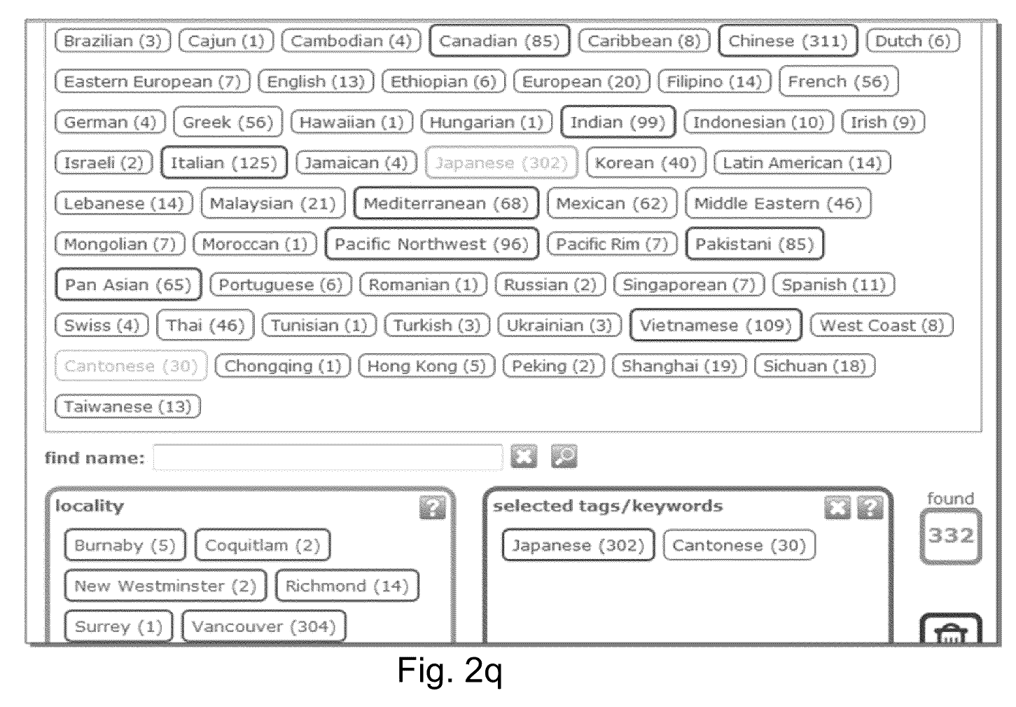

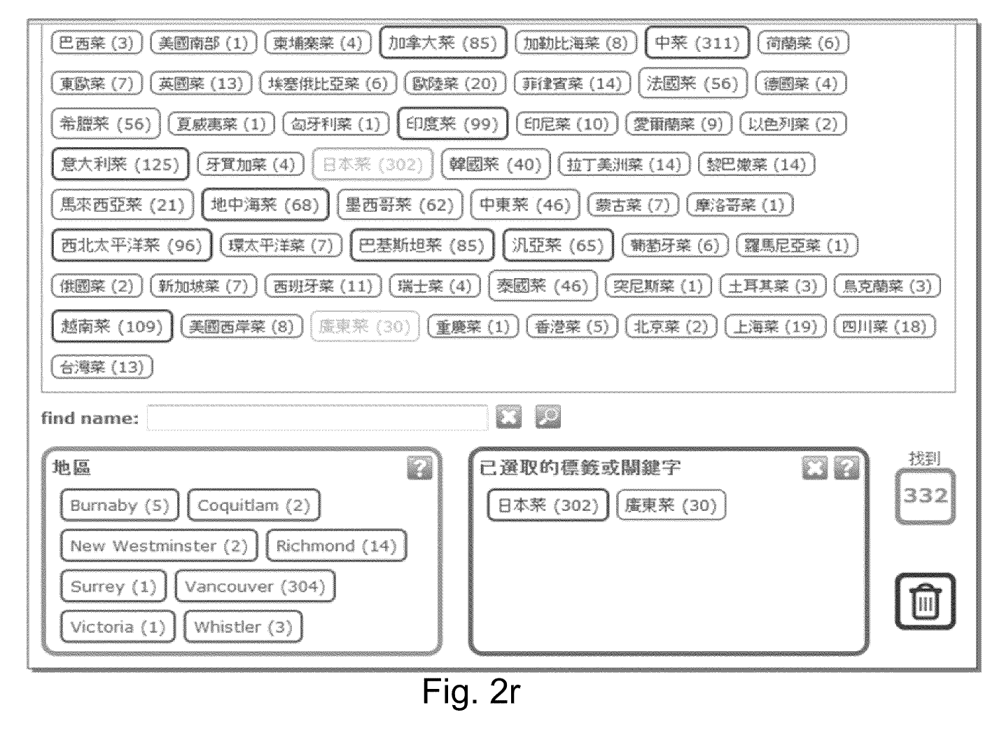

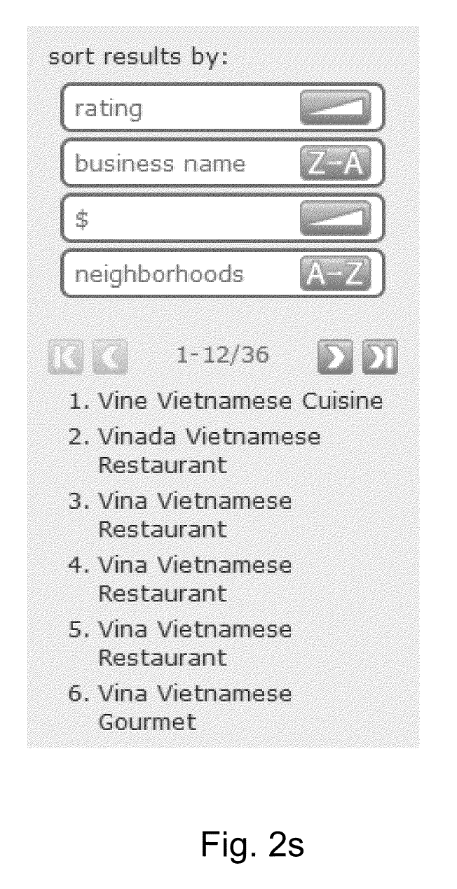

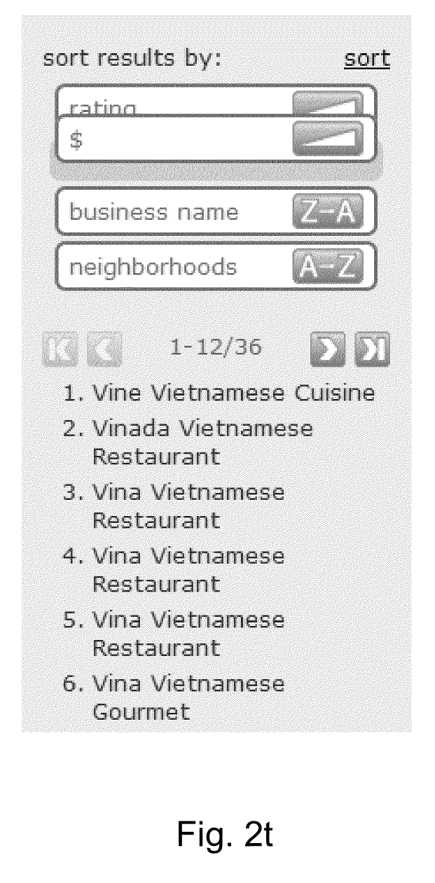

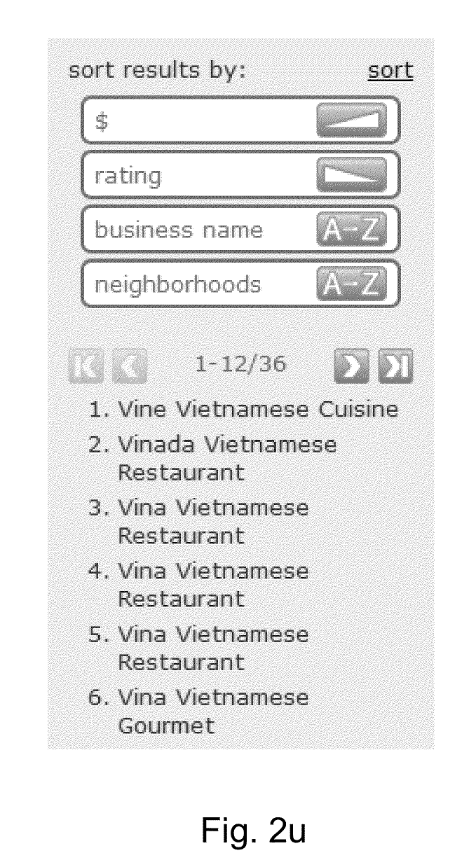

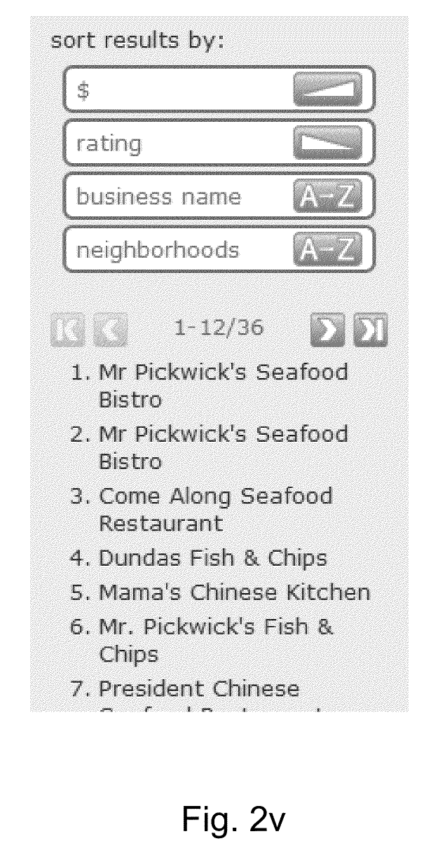

FIG. 2a shows a view of a user interface in accordance with an embodiment of the invention. As shown, a user has typed in “Chinese” and “Tsim Sha Tsui” to look for Chinese restaurants in Tsim Sha Tsui (an area in Hong Kong). As can be seen, a comma is used as the separator, however, in other embodiments, other separators such as a blank space, a semi-colon, a semi-comma, or a hyphen, etc could be used instead. The system will inform the user how many results are found and the user can then decide to narrow the search to find, for example, Cantonese restaurants only by adding “Cantonese” to the keyword sequence, as shown in FIG. 2b.

Alternatively, the user may decide to expand the search to include other areas such as Causeway Bay (another area in Hong Kong) i.e., “Chinese,Tsim Sha Tsui,Causeway Bay”, or include other cuisine types such as Japanese in the keyword sequence, i.e., “Chinese,Tsim Sha Tsui,Japanese”. The latter search is as shown in FIG. 2c and as can be seen, the search result counts are available for the entire keyword sequence as well as the individual keywords to aid the user in deciding whether to further refine the search. In the example shown, Chinese is shown as having 6 result counts, Tsim Sha Tsui has 348 counts, Japanese has 12 counts and the entire phrase “Chinese, Tsim Sha Tsui, Japanese” is shown as having 10 search result counts. This shows that within the database, there are 6 Chinese restaurants listed, 348 restaurants listed in Tsim Sha Tsui, 12 Japanese restaurants listed and there are 10 businesses in Tsim Sha Tsui that are either Chinese or Japanese restaurants. The result counts are updated in real-time as and when the user modifies the keywords.

FIG. 2d shows how auto-suggestion works in accordance with an embodiment of the invention. As shown, when a user selects “restaurants” and types Chinese, the system automatically suggests a Chinese bakery. While the only suggestion shown is a Chinese bakery, in other embodiments, more suggestions may be shown. For example, in FIG. 2e, the auto suggestions “Tsim Sha Tsui”, “Tsim Sha Tsui East” and “Tsing Yi” are shown in response to the user typing in “tsi”.

FIG. 2f shows a flowchart of an embodiment of how an auto-suggest module functions. As shown, when a user inputs “ch”, the web page sends “ch” to the server asynchronously while the user continues to type and the auto-suggest module finds keywords starting with “ch” and returns suggestions and search counts. When the user finishes typing the keyword, the web page will send the word “Chinese” to the server asynchronously while the user continues to type and the auto-suggest module will find matching keywords and associated result count and update the screen display.

Similarly, as the user continues to type tsim sh, the webpage will return “tsim sh” to the server synchronously while the user continues to type, and the auto-suggest module finds keywords starting with “tsim sh” and returns suggestions and result counts. When the user finishes typing the keyword, the web page will send the word “tsim sha tsui” to the server asynchronously while the user continues to type and the auto-suggest module will find matching keywords and associated result count and update the screen display. This process will continue until the user ceases to input keywords. Where applicable, the auto-suggest module may present multiple independent suggestion lists with one or more suggestion lists presented for each keyword in a sequence of keywords as well as the sequence of keywords.

As previously mentioned, the intelligent search does not require users to specify how the keywords are combined. The website's server will make this decision based on the context and rules that have been set up in the website's database. For example, the website will interpret the keywords “Chinese,Tsim Sha Tsui,Causeway Bay” as “Chinese restaurants in Tsim Sha Tsui or Causeway Bay”, and “Chinese,Tsim Sha Tsui,Causeway Bay,Japanese” as “Chinese or Japanese restaurants in Tsim Sha Tsui or Causeway Bay”. This is accomplished by grouping the keywords (also known as tags or labels) in a hierarchy and creating rules to define the relationship between these groups in the hierarchy.

Referring to the table below, keywords of geographical areas and keywords denoting cuisine types may be grouped in separate groups. Within each group, sub-groups may be created where the result set is a sub-set of the main group. For example, information relating to eateries in Hong Kong may be grouped into Geographical Area, Cuisines, Types of Establishments, Types of Payment, Types of Service and Miscellaneous as shown below:

Geographical Areas

Tsim Sha Tsui
Causeway Bay
Central
Wanchai
Yau Ma Tei

Cuisines

```
Chinese
    Cantonese
    Szechuan
    Shanghai
    Peking
Japanese
Western
    French
    Italian
```

Types of Establishment

Restaurants
Diners
Food Court
Hawker Centre
Izakaya
Tavern
Pub
Bar

Types of Payment

credit cards
cash only

Types of Service

BYO
Licensed
Catering
Delivery

Miscellaneous

Parking
wheel-chair access

Although the above show groupings of Hong Kong eateries, it should be apparent that the invention is not limited in application to Hong Kong eateries and a similar grouping could be made for eateries in New York, for example, and for that matter, the subject matter need not be eatery but could be anything that is of interest including but not limited to Jewellery, Medicine, Departmental Store, Hospitals, Hotels, Museums, etc.

When the server receives a keyword sequence, it will look up the keywords and apply pre-defined rules to them. For example, defaults may be ignored, e.g., “restaurants”, i.e., unless the user specifies “Hawker Centre” or “Pub”, the server assumes the user is looking for a restaurant. Keywords belonging to the same group are combined using “OR”, e.g., “Tsim Sha Tsui OR Causeway Bay”, “Chinese OR Japanese”. Keywords belonging to a superset within a group are ignored when a keyword belonging to a subset appears, e.g., “Japanese OR Cantonese OR Szechuan” because “Cantonese” and “Szechuan” are both a subset of “Chinese”, or “Chinese OR Italian OR French” because “Italian” and “French” are subsets of “Western”. Groups of keywords are combined using “AND”, e.g., “Tsim Sha Tsui OR Causeway Bay AND Chinese OR Japanese”. Special rules may apply to exceptions and miscellaneous keywords or there may be no special rules. Furthermore, while not described in details above, other rules may stipulate different methods or use different operators in combining the keywords, e.g., using ‘NOT’ in addition to or instead of “AND” or “OR” as the logical operator.

Applying the above rules, a phrase such as “Chinese,Restaurants,Western,Szechuan” will be interpreted by the server as “find restaurants that serve Western or Szechuan cuisines”. “Central,Wanchai,Chinese,Restaurants,Western,Szechuan” is interpreted as “find restaurants in Central or Wanchai that serve Western or Szechuan cuisine” and the result count will be displayed on the screen. “Tsim Sha Tsui,Chinese,Causeway Bay,Hawker Centre,Food Court,Japanese,” is interpreted as “find Hawker Centre or Food Court outlets in Tsim Sha Tsui or Causeway Bay that serve Chinese or Japanese cuisine” and the result count will be displayed on the screen. On the other hand, a user may wish to specify things to be excluded in the search. For example, NOT (Japanese AND Chinese)=NOT Japanese OR NOT Chinese, or in English: to exclude Chinese and Japanese cuisine in a search means find anything except Chinese and Japanese cuisine, or find anything except Chinese cuisine or find anything except Japanese cuisine.

In order to achieve the above, the businesses need to be tagged or labelled correctly in the first place for the search engine to be able to find the correct results. In one embodiment, a database that uses the correct tags to describe and identify objects may be built manually. In another embodiment, the database may be built programmatically for the WWW. In either case, the search engine may be on a local computer or on the WWW. In the manual embodiment, the information is inputted by a person whereas in the automatic embodiment, automatic programs called “spiders” or “crawlers” search through the WWW and select vital information for use as tags in the database. A tagging module creates tags for the objects and in the process inspects and validates keywords that users use in labelling or tagging their contents whether such keywords are inputted by a person or collected by automatic programs by following pre-defined rules. It will apply rules similar to those described above to further enhance and validate the keywords.

For example, the server maintains a table of geographical areas and knows that Sydney is located in New South Wales in Australia. A user may label a photo with tags such as “Sydney” and “Beach” and the system in accordance with an embodiment of the invention will add “New South Wales” and “Australia” to the photo in the database. This ensures that other users specifying only “New South Wales” (or “Australia”) and “Beaches” will find the photo. Similarly when a user tags a restaurant using “Cantonese”, the tagging module will add an additional tag “Chinese” to the restaurant. If a user enters a keyword that is a default in that category, the keyword is removed, i.e. “restaurant” is removed from a business listing as it is a default, however, “food court” will be retained in the database. If the database is built manually and users enter keywords that do not already exist in the database, the system will prompt users for further information so that the keywords can be classified correctly. In embodiments where the database is built programmatically, the system will follow pre-defined rules for adding keywords. If no relevant rules can be found, the system will alert system staff to create new rules.

In another embodiment, the system may provide modules for multi-language and multi-lexicon support. For example, when a user searches for typhoon, the same search result would be returned if the user searched for hurricane or use the Chinese characters for typhoon. Another example, as shown in FIGS. 2g-j, is that a user will find the same restaurants by typing “sushi”, the Chinese word for “sushi”, i.e., [symbol] ” (traditional Chinese) or “ [symbol] ” (simplified Chinese/Japanese Kanji) or “ [symbol] ” (Japanese Hiragana). In one embodiment, the multi-language and multi-lexicon keyword support is implemented by assigning a unique identifier to each keyword or tag. The identifier may be numeric or it may be any combination of letters, characters, digits or symbols. All keywords that have the same meaning or represent the same group of objects in a particular domain are grouped together (i.e., all keywords about restaurants are grouped together while keywords about digital electronics are grouped in a separate group). This advantageously speeds up the search process when the search engine can determine or deduce what type of objects the users are or likely to be interested in. One keyword is chosen as the primary keyword to represent the group. Only the identifier of the primary keyword is used in tagging an object.

For example, the following words all represent a tropical cyclone, each word is given a unique identifier and purely by way of example, identifier 123 has been chosen as the primary keyword. This identifier will be recorded against any object that can be described as a typhoon.

| Primary | Unique | | |
|---|---|---|---|
| Identifier | Identifier | Keyword | Language |
| 123 | 123 | Typhoon | English |
| 123 | 124 | Hurricane | English |
| 123 | 234 | [symbol] | Chinese, Japanese |
| 123 | 213 | [symbol] | Chinese |
| 123 | 543 | [symbol] | Japanese |
| 123 | 546 | Tropical | English |
| | | Cyclone | |
| 123 | 458 | Taifun | German |

When the server receives a keyword sequence, the keywords are sent to the search engine, which compares the keywords against the above table to find the primary identifier. The identifier is then used by the search engine to look for objects in the database that have this identifier. This way, no matter what language or what vocabulary a user chooses to specify as keywords, as long as they are recognised in the table with the same primary identifier, the same objects will be found. For example, a video has been tagged “Typhoon” and has identifier “123” recorded against it. When the server receives “ [symbol] ” from a Japanese user, it looks up the table, finds the primary identifier “123” that corresponds to “ [symbol] ” and passes it to the search engine to search for all objects that have this identifier. In this way, the multi-language and multi-lexicon modules support the function of the tagging module by converting keywords in different languages into a single primary identifier.

In an alternative embodiment, the system may include a word association search function. The function is designed to interpret user-entered keywords and group them into word sequences so that the search engine can perform searches more effectively/efficiently and the results returned are more relevant. The word association search function examines the keywords and place them in groups of connected character strings (“keyword phrase”) before a search is performed. In other words, the search looks for instances of the words directly next to each other in the target. For example, if a user enters “Chinese restaurants in Sydney” or “Sydney Chinese restaurants”, the search will be performed using “Chinese restaurant” and “Sydney” as keyword phrases; it will return results that contain “Chinese restaurant” together but not return results that contain “Chinese” or “restaurant” as separate words. Similarly if a user enters “Sydney beach houses” or “beach houses in Sydney”, the search will be performed using “beach house” and “Sydney”. As can be seen, the search engine can handle a single-word keyword (e.g., “Sydney”) or a multi-word keyword (e.g., “beach house”).

This technique enables the search to be more efficient when users enter many keywords. There are fewer search iterations when looking for a string of multiple words (e.g., “beach house”) compared to a search looking for the two string of single words as separate words (e.g., “beach” and “house”). The search will also bring back more relevant results as the user in this example is more interested in beach houses than beaches. The way the function works is that it first scans a string of words for punctuation marks and stop words to determine where to split up the word sequence into groups or segments. As shown in FIG. 2k, a stop word is a word that has little or no semantic value (or meaning), e.g., articles (e.g., “a”, “an” or “the”), prepositions (eg “in”, “on”, “at”), or words that perform a grammatical function, e.g., conjunctions (“and”, “or”).

The word groups/segments are then scanned against a vocabulary of multi-word phrases in order to further divide the word segments into keyword phrases. The scan starts by looking for any matching keyword phrase that contains the highest number of words. As shown in FIG. 21, once a match is found, the scan continues towards the end or the beginning of the word segment starting at the position of the matched phrase. This process is repeated until the beginning or the end of the word segment is reached. The keyword phrases created by this process can then be used to commence a search. There may be occasions when more than one keyword phrase with the same number of words can be matched against the word segment. When this happens, the keyword phrase combination that results in the smallest number of single words will be used to commence a search.

The technique described is also applied in converting between traditional Chinese characters and simplified characters, and from characters to pinyin. The majority of traditional Chinese characters have only one equivalent in simplified form (e.g., [symbol] , [symbol] ). However, there is a small group of traditional characters that do not use its simplified form in certain vocabulary (e.g., [symbol] but [symbol] , or [symbol] but [symbol] [symbol] ). In addition, a number of traditional characters share the same simplified form (e.g., [symbol] ). When converting from simplified characters to traditional characters, the context will determine which traditional characters should be used. Similarly, a large number of Chinese characters have more than one pronunciation (e.g., [symbol] [symbol] Yin Hang, [symbol] Xing Dong, [symbol] Da Sha, [symbol] Xia Men). When converting Chinese characters to Pinyin, the context will also determine what pronunciation should be used.

Word Association can be used to achieve conversion with a very high degree of accuracy using a vocabulary list that records the correct traditional characters, simplified characters or Pinyin to be used. A string of characters are first divided into groups or segments by identifying punctuation marks and stop words. The segments are then scanned against the vocabulary list starting with the ones with the most number of characters. When a match is found, the scan continues towards the beginning and the end of the word segment. When this process is completed, there will be a collection of multi-character and single character phrases. Multi-character phrases will be converted to the traditional characters, simplified characters or Pinyin suggestions recorded in the vocabulary list, single-characters will be converting to their traditional or simplified character equivalence or in the case of Pinyin conversion, the most common pronunciation will be used in the conversion.

In yet another embodiment, the system includes a graphical module that can be used to build or create a collection of keywords. Referring to FIG. 2m, a list of keywords is presented to users in a box on one side of the screen. While a rectangular box is shown, in other embodiments, a bin or a bucket may be used instead and other shapes may be used, e.g., a square or any other shapes. The users may use their mouse to drag and drop the keywords they desire into a target drop zone on the other side of the screen to indicate that they have selected these keywords as search keywords. The drop zone can similarly be in any shape or form, e.g., a square, a bin or a bucket. Once the drop zone accepts the keywords, they will be displayed on the screen to indicate that they have been accepted. Should the user decides to delete any of the accepted keywords, the user may likewise drag and drop the keywords from the drop zone back toward the list of keywords.

Similar to the textual input method, users are not required to select keywords in any particular order. The Intelligent Search System will determine how these keywords are combined in the search. Referring to FIG. 2n, after the keywords are accepted, the website may display the number of results founds for each keyword (as shown next to the respective keywords), and/or the number of results found for the entire collection of keywords (as shown on the top of the drop zone). In another embodiment, the graphical module may use a map as a target drop zone. When users drag a keyword to the map, the map will mark the location of businesses that match the keyword and other keywords that have been accepted. More details about each of these businesses may be revealed when the user is satisfied with the search results.

Furthermore, tags or keywords may be divided into groups and placed in different areas of the webpage. For example, there may be a “cuisine tags” area for tags related to cuisines of different countries and regions or a “selected tags” area for tags that are used by the search engine as search criteria. Users may further choose a tag, e.g., “Japanese” from the cuisine tags and place it in the “selected tags” area by pointing and clicking the “Japanese” tag or dragging it from the “cuisine tags” area to the “selected tags” area. Similarly, a tag may be removed from the search criteria by dragging it from the “selected tags” area to a rubbish bin or trash icon or alternatively, by clicking it when it appears in the “selected tags” area or by dragging it back to the cuisine tags. All tags in the “selected tags” area are used by the search engine to conduct a search. As with the keywords, these tags do not need to be selected in any particular order as the search engine will determine the appropriate rules to apply to the tags when searching for results.

While tags are displayed for user's selection, users may also enter the name of, for example, a restaurant or department store as the search criteria. Similar to where keywords or tags are used as the search criteria, should the name of the restaurant or department store contain two or more words, the search engine will determine the appropriate rules to apply to the different words. As such, the restaurant or department store need not be entered precisely. For example, a restaurant with the name “Shumo Sushi” will be found regardless of whether users typed in “Sushi Shumo” or “Shumo Sushi” as the search criteria.

As indicated earlier, where users enter keywords as search criteria, counts are available for the entire keyword sequence as well as the individual keywords to aid the user in deciding whether to further refine the search. Where the users use the available tags and drag and drop them into the selected area as shown in FIGS. 2o and 2p, the intelligent search engine may return a list of sub-totals for the unselected tags to give users more information on how to further refine the search. For example, when searching for a restaurant using the tags, the search engine may return results that match the selected tags, as well as return a list of localities and the number of matches in the localities listed. Users may then add or further refine the search by selecting one or more of the localities listed.

Referring to the example user interface shown in FIG. 2o, a user has selected the “Sushi” tag as search criteria. A search count icon, or alternatively a search counter, shows a total of 230 results that match the tag “Sushi” and four “locality” tags are shown in the box on the left hand side, which shows how many results are found in each locality. FIG. 2p shows another example user interface where users have added the “Whistler” and “Richmond” locality tags to the “selected tags” area. Taking into account “Whistler” and Richmond” as additional search criteria, the search counter now shows a total of 4 results, indicating that there are 4 matches of eateries serving sushi found in Whistler and Richmond.

If instead of selecting Richmond and Whistler or any of the locality tags shown, the users specified one or more locations by inputting the name of the location, the search engine will return a list of “locality tags” including the locations specified by the users and the number of results found in those locations. In another embodiment, the user may also specify a location by locating an area on a map (e.g., Google Map). Regardless of the mode of input, as can be seen from FIGS. 2o and 2p, the number of results will be shown for the individual locations, regardless of whether such location has been selected by the user as search criteria.

It should be apparent that the user may search by location first, in which case, the search engine will return tags and a sub-count for each tag in that location. For example, if the users specified a location in downtown Vancouver, the search engine may return a list of tags such as “Chinese”, “Japanese”, “food” or “consumer goods” and their counts, indicating how many Chinese or Japanese restaurants, food or consumer goods outlets are found in that area. In all the examples above, users may combine the search with a full or partial business name and if the name contains more than one word, the name does not need to be in the right order.

While the search counter is used for displaying the result count for the total result that matches all the tags selected, it may also be used as an animated symbol for letting users know that the computer or the webpage is still functioning while the webpage waits for the server to respond. In other words, the search counter may be used as an indicator to users that the users' search requests are being processed. Examples of events that may require the webpage to wait for the server to respond may include:

Files or images to be uploaded to the site

Search requests submitted by users

Loading large webpages or content

Payment approval in a financial transaction

The animated search counter, while the webpage is waiting for a response, will show one or more digits changing in a fraction of a second, giving it the appearance of numbers changing quickly. The animated search counter may be built using animated GIF where each frame making up the animated GIF file shows a different number as shown in the table below.

| num- | | | | | | | | | |
|---|---|---|---|---|---|---|---|---|---|
| ber | 131 | 345 | 239 | 947 | 285 | 842 | 597 | 681 | 549 |
| Frame | 1 | 2 | 3 | 4 | 5 | 6 | 7 | 8 | 9 |

Theses frames may be played continuously at a high speed, for e.g., 12 frames per second, to give the desired appearance. Alternatively, the same result may be achieved by having the same number over several frames running the animation at a higher speed.

In addition, the multi-language or multi-lexicon support module may further include an instantaneous language change feature. Many websites that support multi-lingual searches and/or provide multi-lingual user-interfaces do so by reloading a page and displaying it in the new language selected by users when the users select a different language. As the page is reloaded from the server, data previously entered by the users will be lost and the users will need to start the search all over again. The instantaneous language change feature, on the other hand, does not reload the page to change the webpage language. Instead, as soon as users select a new language supported by the search engine, all the label, texts and dialogs, including static and dynamic content (i.e., text, dialogs and website elements that change as a result of user interaction, e.g., tags that may or may not appear depending on the location specified or the businesses found in a search, tags that have been selected, etc), will change to the new language instantaneously without reloading the page, thus leaving user-entered data intact and unchanged. Moreover, users may switch between the languages supported by the search engine as often and as many times as they desire with no information being lost thereby resulting in the users experiencing a seamless and an uninterrupted user experience during a search.

Referring to FIG. 2q, which shows a webpage after a user has selected two tags, “Japanese” and “Cantonese”. As shown, these two tags appear in the “selected tags” area and the original tags in the “cuisine tags” area are greyed-out. In addition, the search counter shows that 322 results were found. FIG. 2r shows the same page after a user changes the webpage language to traditional Chinese. As can be seen, all the labels in the user-interface are now displayed in Chinese and the tags in the “selected tags” area, which were previously “Japanese” and “Cantonese” are now shown as “ [symbol] ” and “ [symbol] ”, respectively. As in FIG. 2q, the equivalent tags in the “cuisine tags” area are greyed-out as before.

The intelligent search engine is further capable of multi-language phonetic search in the languages it supports. For example, in English, if users type in foto as search criteria, most established search engines will ask whether users intend to search for “photo”. This works for words that sound the same or similar. Apart from providing this feature in English, the intelligent search engine also provides the feature for Cantonese, Mandarin, Japanese and other languages or dialects supported by the search engine. For example, if users intend to search for “ [symbol] ” but entered “ [symbol] ” instead, the intelligent search engine will still find “ [symbol] [symbol] ” as “ [symbol] ” and “ [symbol] ” have the same pronunciation. This also works for characters that sound similar.

In another embodiment, the intelligent search engine is capable of interactive sort, i.e., sorting in different directions for different attributes (e.g., descending order in rating, then ascending order in price, then ascending order in name). This is particularly convenient to users when the server returns a large number of results in a search. In such embodiments, the graphical module further comprises a graphical user interface that allows users to specify multiple sorting attributes in different directions. As shown in FIG. 2s, the graphical user interface presents attributes available for sorting in a vertical list (hereinafter known as an interactive sort order). The attribute at the top of the list is the primary factor for sorting, followed by the attribute next on the list and so on. Hence, the interactive sort order shown in FIG. 2s will be used by the search engine to sort results first by rating (in ascending order), the business name (in descending order), then price range (in ascending order), then the name of the neighbourhood (in ascending order).

Users may re-arrange the sort order simply by moving the attributes using drag and drop. An example is as shown in FIG. 2t, where the price range attribute is being dragged from third place to first place. The result set will be sorted in the new sort order when users click on the “sort” link or button, or when the attribute is dropped in place. In addition, users may also specify a sort direction for each attribute independent of other attributes by simply clicking on the direction icon at the right hand side of the attribute to change direction. Referring to FIG. 2u, the interactive sort order shows a change in the sort direction of the business name following a click on the direction icon by users. Whereas FIG. 2t shows sorting of business name in descending order, FIG. 2u shows sorting of business name in ascending order. The result set will be sorted in the new sort order when users click on the “sort” link or button. As shown, the results will now be sorted first by price range (in ascending order), then rating (in descending order), then business name (in ascending order), then the name of the neighbourhood (in ascending order) and the results after the new sort order is as shown in FIG. 2v.

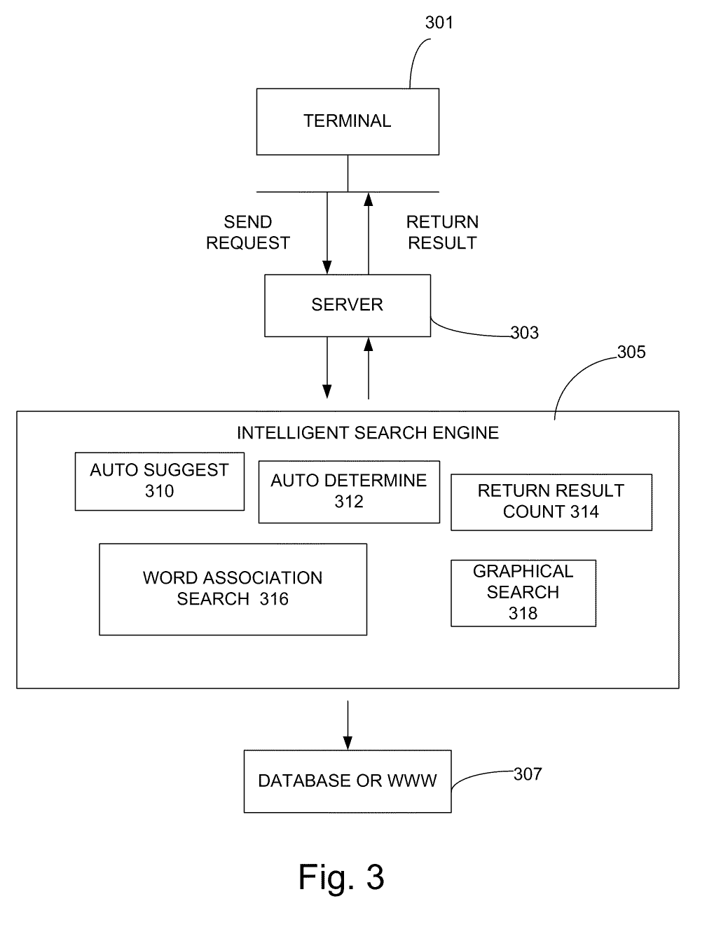

FIG. 3 shows a block diagram of a system for processing a search query in accordance with an embodiment of the invention. As shown in FIG. 3, a terminal 301 is connected to a server 303. Server 303 is in communication with an intelligent search engine 305, and intelligent search engine 305 is connected to the WWW or a private database 307 or both. The intelligent search engine 305 includes an auto suggest module 310 for auto-suggesting one or more lists of keywords for a sequence of keywords and each word in the sequence of keywords, an auto determine module 312 for automatically determining how keywords specified by users should be combined using union or intersection including determining how all user-entered or selected keywords should be combined, and a return result count module 314 for returning real-time search result counts to the user.

In an alternative embodiment, the intelligent search engine 305 may further comprise a word association search module 316 for more effective searching and/or a graphical module 318 as alternative means for users to enter in search keywords. Although not shown in FIG. 3, in other embodiments, the intelligent search engine 305 may further include a tagging module for ensuring keywords are properly spelt and tags for each keyword properly created so that the same objects are tagged with the same identifier regardless of input language when specifying tags in languages supported by the search engine. The intelligent search engine may further comprise a multi-language support module that enables a user to obtain the same search result regardless of input language when specifying keywords in languages supported by the search engine and/or a multi-lexicon support module to enable a user to obtain the same search result when the user enters one or more of a number of words having the same meaning.

In embodiments where a graphical module 318 is included, tags or keywords may be divided into groups and placed in different areas of the webpage and the auto suggest module 310 may suggest tags that may be dragged and dropped (with alternative being point and click) from one area of the webpage into a “selected tags” area and return result count module 314 will return result count for the individual tags, whether or not selected to be dropped into the selected tags area, as well as the result count for the total number of matches for all the selected tags. In another embodiment, the return result count module 314 may further function as an animated symbol for showing users that the users' search request is being processed, or in other words, the webpage is functioning but waiting for response from the server. In other embodiments, the multi-language support module may further include an instantaneous language change feature that changes the webpage into a new language without reloading the page, thus leaving user-entered data intact.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A search engine comprising:
a return result count module for determining the search result count for a sequence of keywords as well as each keyword in the sequence of keywords and returning the result count in real time; and
wherein the return result count module also function as an animated symbol to inform a user that the user's request is being processed.

2. The search engine of claim 1 further comprising a graphical module wherein keywords are divided into groups and shown as tags that may be selected by point and click or dragged and dropped from one area of the webpage to another area of the webpage.

3. The search engine of claim 2 further comprising an auto-suggest module that may suggest a list of tags in response to a user's input of a particular tag.

4. The search engine of claim 2 further comprising an auto-determine module that determines how the tags should be combined thereby allowing a user to find the same results without having to specify the order of the tags.

5. The search engine of claim 1 further comprising an auto-determine module that allows a user to find the same result regardless of whether the user has reversed the order of a name comprising more than one word when entering the name.

6. The search engine of claim 1 further comprising a multi-language support module that includes an instantaneous language change feature that changes static and/or dynamic content of a webpage into a different language while keeping user-entered data intact.

7. The search engine of claim 1 further comprising a multi-language support module that includes an instantaneous language change feature that changes static and/or dynamic content of a webpage into a different language without reloading the webpage.

8. The search engine of claim 6 wherein the instantaneous language change feature allows users to switch between languages support by the search engine multiple times with no information being lost.

9. The search engine of claim 7 wherein the instantaneous language change feature allows users to switch between languages support by the search engine multiple times with no information being lost.

10. The search engine of claim 1 further comprising a multi-language support module that allows multi-language phonetic searches.

11. The search engine of claim 2 wherein the graphical module further comprises a graphical user interface that allows users to specify multiple sorting attributes in different directions.

12. A computer implemented method for searching comprising changing a webpage into a different language without reloading the webpage.

13. The method of claim 12 further comprising changing a webpage into a different language without losing user entered data.

14. The method of claim 12 further comprising allowing users to switch between languages supported by the search engine multiple times with no information being lost.

15. The method of claim 12 further comprising allowing multi-language phonetic searches.

16. A computer implemented method for searching comprising:
using an animated counter for indicating to users that a search is being processed.

17. The method of claim 16 further comprising allowing users to specify multiple sorting attributes in different directions.
